(19) United States
(12) Patent Application Publication
(10) Pub. No.: US 2014/0185950 A1
(43) Pub. Date: Jul. 3, 2014

(54) PROGRESSIVE ENTROPY ENCODING

(71) Applicant: MICROSOFT CORPORATION, Redmond, WA (US)

(72) Inventors: Damien Saint Macary, Redmond, WA (US); Sridhar Sankuratri, Redmond, WA (US)

(73) Assignee: Microsoft Corporation, Redmond, WA (US)

(21) Appl. No.: 13/729,679

(22) Filed: Dec. 28, 2012

(51) Int. Cl. G06T 9/00

(52) U.S. Cl. CPC G06T 9/005
USPC 382/251; 382/232

(57) ABSTRACT

A method for progressively encoding image tile data is disclosed. The method may include receiving indication that image tile data is to be updated. The method may further include dividing the image tile data into one or more parts and encoding an initial data part in a first pass. The method may also include transmitting first pass data to a client. The method may then include reintroducing at least a portion of the data removed from the initial data part to form a second data part, encoding the second data part in a second pass, and transmitting the second pass data to the client.

### BACKGROUND

Remote computing systems can enable users to remotely access hosted resources. Servers on the remote computing systems can execute programs and transmit signals indicative of a user interface to clients that can connect by sending signals over a network conforming to a communication protocol such as the TCP/IP protocol. Each connecting client may be provided a remote presentation session, i.e., an execution environment that includes a set of resources. Each client can transmit signals indicative of user input to the server and the server can apply the user input to the appropriate session. The clients may use remote presentation protocols such as the Remote Desktop Protocol (RDP) to connect to a server resource. In the remote desktop environment, data representing graphics to be transmitted to the client are typically compressed by the server, transmitted from the server to the client through a network, and decompressed by the client and displayed on the local user display. Various schemes may be used to minimize the size of the graphics data that needs to be transmitted. One such scheme may include dividing the graphics data into tiles and sending only the tiles that have changed since a previous transmission. However, the changed tiles still need to be encoded and transmitted, typically requiring significant network bandwidth and a significant number of processor computation cycles to compress and decompress the tiles. Such processing requirements may have a direct effect on the data transmission/decoding latency from the server to the client and negatively impact the remote user's experience.

### SUMMARY

This summary is provided to introduce a selection of concepts in a simplified form that are further described below in the Detailed Description section. This summary is not intended to identify key features or essential features of the disclosure subject matter, nor is it intended to be used as an aid in determining the scope of the disclosure.

Embodiments herein provide systems and methods for compressing image tile data. An image compression method and apparatus capable of encoding a bitmap image is described. In one embodiment, a progressive encoder divides image tile data into a plurality of parts and processes a first part of the plurality of parts. The first part may be obtained by quantizing tile coefficients to remove one or more bits. The progressive encoder may entropy-encode the first part coefficients, send the encoded first data to a client, reintroduce a second part, including reintroducing at least one of the removed bits, entropy-encode the second part, and send the encoded second part data to the client. Subsequent parts may be reintroduced, entropy-encoded, and sent to the client until all bits have been restituted or until a target quality is achieved.

An embodiment includes a method for progressively encoding image tile data. The method may include receiving indication that image tile data is to be updated. The method may further include dividing the image tile data into one or more parts and encoding an initial data part in a first pass. The method may also include transmitting first pass data to a client. The method may then include reintroducing at least a portion of the data removed from the initial data part to form a second data part, encoding the second data part in a second pass, and transmitting the second pass data to the client.

A computer-readable medium comprising executable instructions that, when executed by a processor, progressively encodes image tile data is also disclosed. The computer-readable medium includes instructions executable by the processor for: receiving indication that image tile data is to be updated; dividing the image tile data into one or more parts; encoding an initial data part in a first pass; transmitting first pass data to a client; reintroducing at least a portion of the data removed to create the initial data part; encoding the second data part in a second pass; and transmitting the second pass data to the client.

A computer-readable medium comprising executable instructions that, when executed by a processor, progressively encodes image tile data is also disclosed. The computer-readable medium includes instructions executable by the processor for: receiving indication that image tile data is to be updated; dividing the image tile data into one or more parts; encoding an initial data part in a first pass, the initial data part encoded using a Run-Length Golomb Rice algorithm; transmitting first pass data to a client; reintroducing at least a first portion of the data removed from the initial data part to form a second data part; encoding the second data part in a second pass, the second pass encoded using a Simplified Run-Length algorithm; transmitting the second pass data to the client; reintroducing at least a second portion of the data removed from the initial data part to form a second data part; and transmitting the at least a second portion of the data to the client as raw data.

### BRIEF DESCRIPTION OF THE DRAWINGS

Referring now to the drawings in which like reference numbers represent corresponding parts throughout:

FIG. 1 illustrates the high level architecture of a system for providing progressively encoding bitmap data according to an embodiment of the disclosure;

FIG. 2 is a system diagram illustrating the components for providing progressively encoding bitmap data according to an embodiment of the disclosure;

FIG. 3 illustrates a routine for providing progressively encoding bitmap data according to an embodiment of the disclosure;

FIG. 4 is flow diagram illustrating a discrete wavelet transform for providing progressively encoding bitmap data according to an embodiment of the disclosure;

FIG. 5 is diagram illustrating code block sections for providing progressively encoding bitmap data according to an embodiment of the disclosure;

FIG. 6 is a simplified block diagram of a computing system in which embodiments of the present invention may be practiced;

FIG. 7A illustrates one embodiment of a mobile computing device executing one or more embodiments disclosed herein;

FIG. 7B is a simplified block diagram of an exemplary mobile computing device suitable for practicing one or more embodiments disclosed herein; and

FIG. 8 is a simplified block diagram of an exemplary distributed computing system suitable for practicing one or more embodiments disclosed herein.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

Embodiments are provided to progressively encode an input image. Methods and systems providing improved bitmap image quality are disclosed. In the embodiments described herein, an entropy encoder may progressively encode processed bitmap data until a desired image quality is achieved.

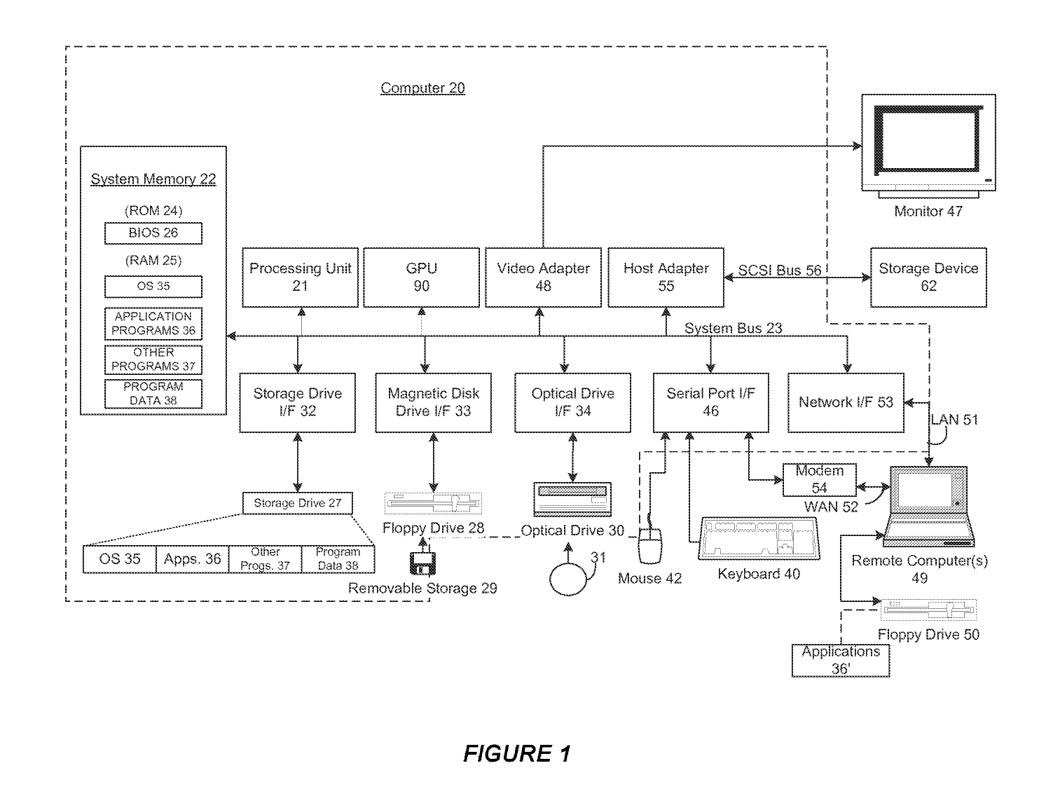

Embodiments of the invention may execute on one or more computer systems. FIG. 1 and the following discussion are intended to provide a brief general description of a suitable computing environment in which embodiments of the invention may be implemented.

FIG. 1 depicts an example general purpose computing system. The general purpose computing system may include a conventional computer 20 or the like, including processing unit 21. Processing unit 21 may comprise one or more processors, each of which may have one or more processing cores. A multi-core processor, as processors that have more than one processing core are frequently called, comprises multiple processors contained within a single chip package.

Computer 20 may also comprise graphics processing unit (GPU) 90. GPU 90 is a specialized microprocessor optimized to manipulate computer graphics. Processing unit 21 may offload work to GPU 90. GPU 90 may have its own graphics memory, and/or may have access to a portion of system memory 22. As with processing unit 21, GPU 90 may comprise one or more processing units, each having one or more cores.

Computer 20 may also comprise a system memory 22, and a system bus 23 that communicative couples various system components including the system memory 22 to the processing unit 21 when the system is in an operational state. The system memory 22 can include read only memory (ROM) 24 and random access memory (RAM) 25. A basic input/output system 26 (BIOS), containing the basic routines that help to transfer information between elements within the computer 20, such as during start up, is stored in ROM 24. The system bus 23 may be any of several types of bus structures including a memory bus or memory controller, a peripheral bus, or a local bus, which implements any of a variety of bus architectures. Coupled to system bus 23 may be a direct memory access (DMA) controller 80 that is configured to read from and/or write to memory independently of processing unit 21. Additionally, devices connected to system bus 23, such as storage drive I/F 32 or magnetic disk drive I/F 33 may be configured to also read from and/or write to memory independently of processing unit 21, without the use of DMA controller 80.

The computer 20 may further include a storage drive 27 for reading from and writing to a hard disk (not shown) or a solid-state disk (SSD) (not shown), a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are shown as connected to the system bus 23 by a hard disk drive interface 32, a magnetic disk drive interface 33, and an optical drive interface 34, respectively. The drives and their associated computer-readable storage media provide non-volatile storage of computer readable instructions, data structures, program modules and other data for the computer 20. Although the example environment described herein employs a hard disk, a removable magnetic disk 29 and a removable optical disk 31, it should be appreciated by those skilled in the art that other types of computer readable media which can store data that is accessible by a computer, such as flash memory cards, digital video discs or digital versatile discs (DVDs), random access memories (RAMs), read only memories (ROMs) and the like may also be used in the example operating environment. Generally, such computer readable storage media can be used in some embodiments to store processor executable instructions embodying aspects of the present disclosure. Computer 20 may also comprise a host adapter 55 that connects to a storage device 62 via a small computer system interface (SCSI) bus 56.

A number of program modules comprising computer-readable instructions may be stored on computer-readable media such as the hard disk, magnetic disk 29, optical disk 31, ROM 24 or RAM 25, including an operating system 35, one or more application programs 36, other program modules 37, and program data 38. Upon execution by the processing unit, the computer-readable instructions cause actions described in more detail below to be carried out or cause the various program modules to be instantiated. A user may enter commands and information into the computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A display 47 or other type of display device can also be connected to the system bus 23 via an interface, such as a video adapter 48. In addition to the display 47, computers typically include other peripheral output devices (not shown), such as speakers and printers.

The computer 20 may operate in a networked environment using logical connections to one or more remote computers, such as a remote computer 49. The remote computer 49 may be another computer, a server, a router, a network PC, a peer device or other common network node, and typically can include many or all of the elements described above relative to the computer 20, although only a memory storage device 50 has been illustrated in FIG. 1. The logical connections depicted in FIG. 1 can include a local area network (LAN) 51 and a wide area network (WAN) 52. Such networking environments are commonplace in offices, enterprise wide computer networks, intranets and the Internet.

When used in a LAN networking environment, the computer 20 can be connected to the LAN 51 through a network interface or adapter 53. When used in a WAN networking environment, the computer 20 can typically include a modem 54 or other means for establishing communications over the wide area network 52, such as the INTERNET. The modem 54, which may be internal or external, can be connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used.

In an embodiment where computer 20 is configured to operate in a networked environment, OS 35 is stored remotely on a network, and computer 20 may netboot this remotely-stored OS rather than booting from a locally-stored OS. In an embodiment, computer 20 comprises a thin client where OS 35 is less than a full OS, but rather a kernel that is configured to handle networking and display output, such as on monitor 47.

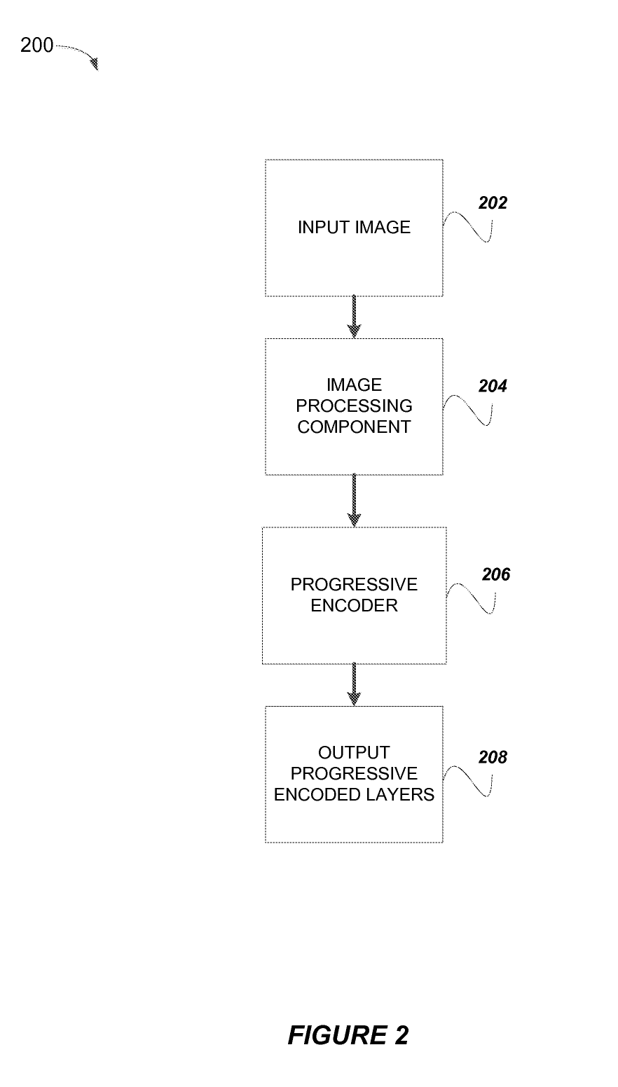

FIG. 2 depicts an example process flow for progressively encoding input bitmap data. In embodiments, the process flow of FIG. 2 may be implemented as processor-executable instructions stored in memory 22 of FIG. 1, and executed by processor 21 to cause the process flow to occur. It may be appreciated that there are embodiments of the invention that do not implement all components depicted in FIG. 2, or that implement the components (or a subset thereof) in a different permutation than is depicted in FIG. 2.

The input bitmap data 202 may be initially transformed by image processing component 204. The data processed by image processing component 204 may be a frame of image data in a remote presentation session (sometimes referred to herein as “graphical data”). After image processing, the data frames may then be encoded via progressive encoder 206, described below in further detail.

The progressive encoder 206 may be configured to send multiple versions of the same tile over a period of time, with each subsequent version becoming more refined and improving in quality. In this manner, a high frame rate may be maintained by reducing quality to increase the overall based on client bandwidth. To progressively transmit a tile, the progressive encoder 206 may be configured to repeat a progressive entropy encoding operation numerous times with the same input tile to generate multiple payloads that may be consumed by a decoder to re-create the tile in its entirety. Sending progressive iterations of a bitmap component may be accomplished by executing a first progressive pass for an individual component or tile, followed by subsequent upgrade progressive passes for the tile.

A remote presentation server (not shown) that implements the process flow of FIG. 2 may then take an progressive frame layers 208 (e.g. a display of a computer desktop over time) output from the progressive encoder 206, and process them for transmission to a client across a communications network.

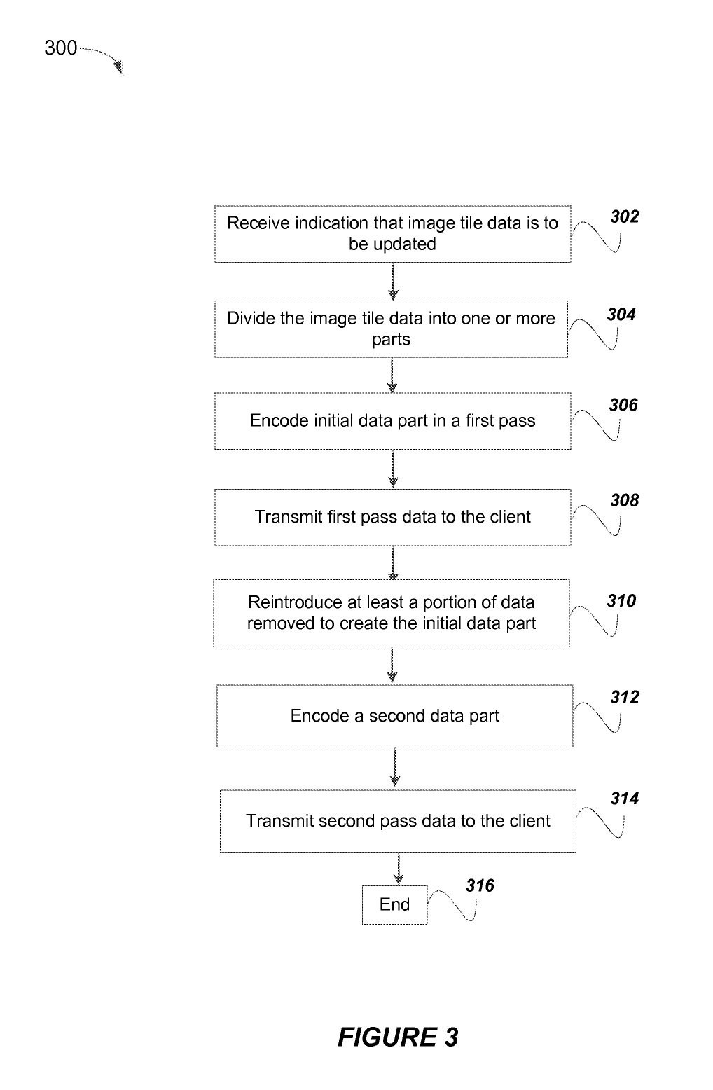

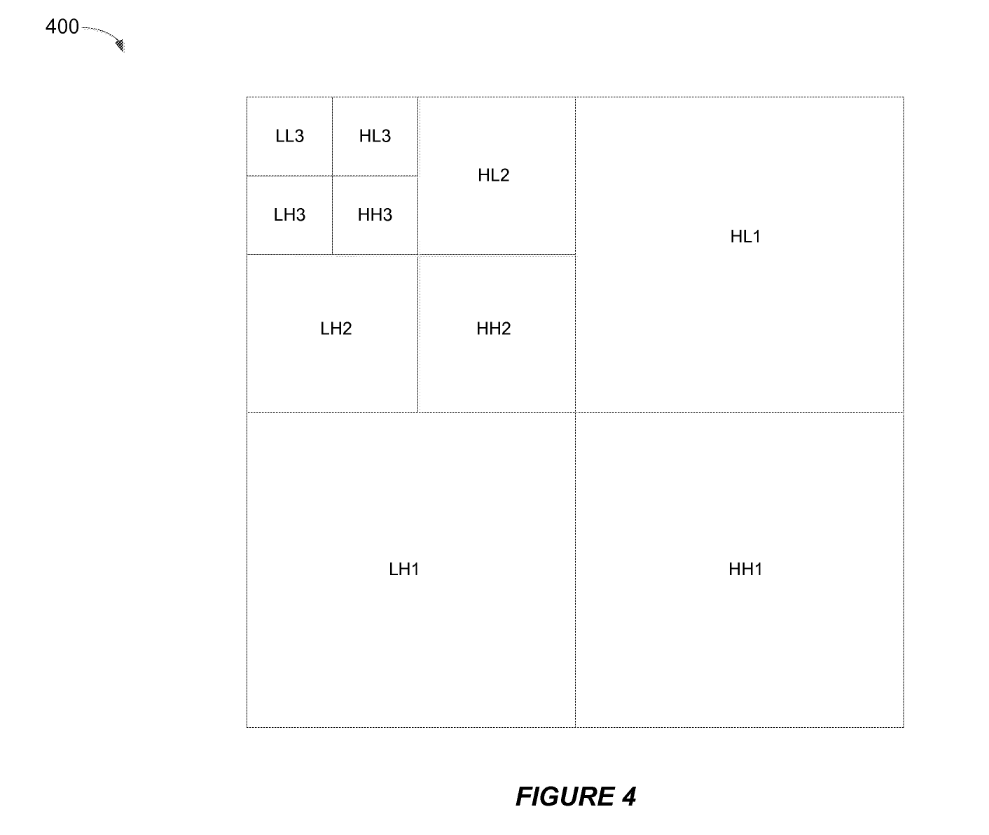

Turning now to FIG. 3, a flow diagram illustrating a routine 300 for progressively encoding a bitmap image, in accordance with various embodiments, will now be described. In some embodiments, the routine 300 may be implemented via the system components and/or applications described above with respect to FIGS. 1-2. Further examples of the systems and methods described herein are also provided in FIGS. 4-6. Additional or alternative embodiments using components other than those described herein are also contemplated.

The routine 300 begins at operation 302, where an indication that data is to be updated is received. In one example, a user may be scrolling on a remotely-accessed web page via a graphical user interface. On the interface, the image displayed on the screen may be divided into tiles. The progressive encoder 206 may be configured to determine which tiles have changed from a previous frame and which tiles have remained static. Tiles that have changed will generate new data, tiles that have remained static for a period of time may be progressively updated using the progressive encoder 206. As the user scrolls, a lower quality image of the webpage may be displayed. Specifically, newly displayed data may be encoded, highly compressed and sent to the client to be decoded. Thus, new data regions may appear in low quality. If a region does not receive an update in a certain amount of time, the progressive encoding may be triggered. For instance, when the user stops scrolling, a server computer may receive an update notification indicating that an image section may be progressively encoded to improve the image quality. Progressively encoded image subsections (or parts) may be transmitted to a client computer individually. As the client computer receives the progressively encoded image parts, the client computer may decode the image parts and add a subsequently received image part to a previously (or currently) received image part. The quality of the image may incrementally increase until the image quality reaches an acceptable level.

From operation 302, the routine 300 continues to operation 304, where a tile of an input image may be divided into one or more tile parts. The data in each tile part may be encoded and transmitted separately. Each tile component may first be transformed via an image transform mechanism. An image transform is a transform that may be used to generate an array of coefficients that correspond to the frequencies present in the image. An example of an image transform is a discrete wavelet transform (DWT). A DWT is a wavelet transform in which the wavelets are discretely (as opposed to continuously) sampled. A DWT is commonly used to transform an image into a representation that is more easily compressed than the original representation, and then compress the post-transform representation of the image. A DWT is reversible, inasmuch as where a DWT may be used to transform an image from a first representation to a second representation, there is an inverse transform that may be used to transform the image from the second representation to the first representation.

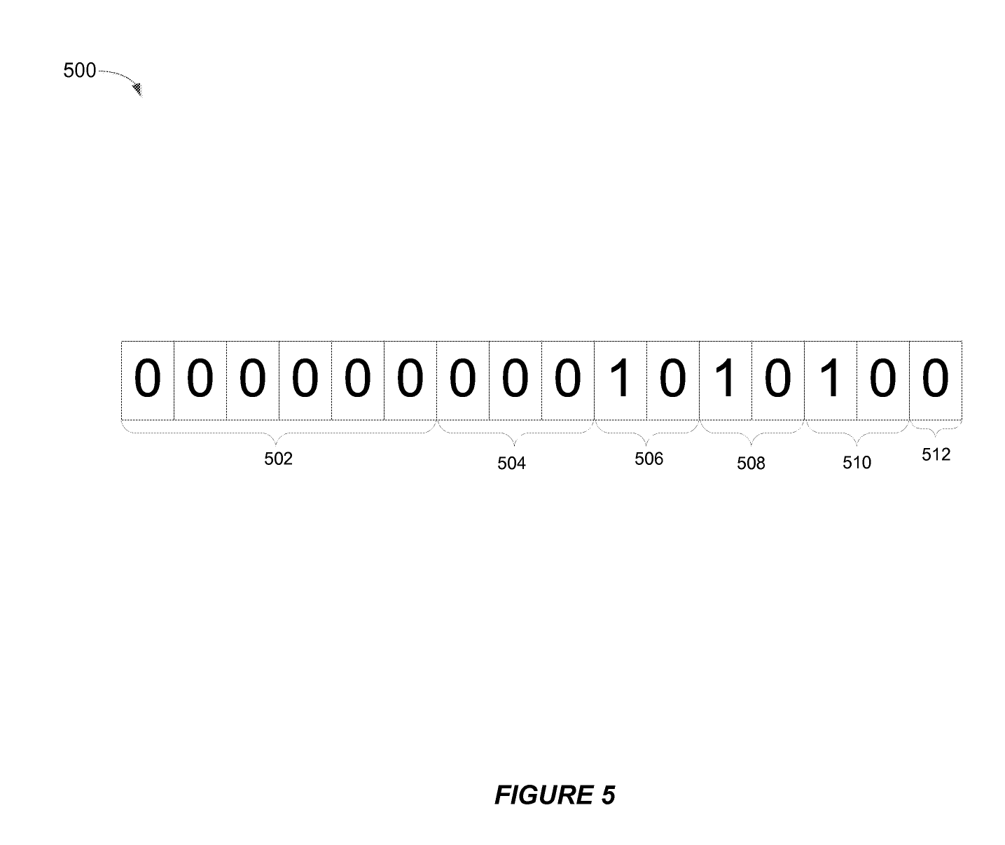

In preferred embodiments, a transformed tile may comprise a plurality of color components. For example, a 64×64 pixel tile may include an array of 4,096 components (or coefficients). A DWT decomposes the individual color components of the pixel tile of an image into corresponding color sub-bands. The color sub-bands may include a plurality of transform coefficients. For example, after a single transform, an image may be decomposed into four sub-bands of pixels, one corresponding to a first-level low (LL) pass sub-band, and three other first-level sub-bands corresponding to horizontal (HL), vertical (LH), and diagonal high pass (HH) sub-bands. Generally, the decomposed image shows a coarse approximation image in the LL sub-band, and three detail images in higher sub-bands. Each first-level sub-band is a fourth of the size of the original image (i.e., 32.times.32 pixels in the instance that the original image was 64.times.64 pixels). The first-level low pass band can further be decomposed to obtain another level of decomposition thereby producing second-level sub-bands. The second-level LL sub-band can be further decomposed into four third-level sub-bands. FIG. 4 illustrates a DWT tile including 10 exemplary frequency bands: LL3, LH3, HL3, HH3, LH2, HL2, HH2, LH1, HL1, and HH1. High pass bands may be associated with image detail information, and low pass bands may be associated with scaling functions. It should be noted that any transform capable of transforming data in a scenario where input data comprises more low values than high values may be utilized. The sub-bands may be further partitioned into rectangular code blocks, and each code block may then be entropy encoded. FIG. 5 illustrates an example of a rectangular code block to be encoded.

After the data has been transformed, the transformed data may be quantized. Quantization allows data to be more easily compressed by converting it from a larger range of possible values to a smaller range of possible values. For instance, the coefficients in the array may then be quantized to both reduce the range of values that a coefficient may have, and zero-out coefficients with small values. Quantizing the data may enable the data to be more greatly compressed at a later stage of the process flow of FIG. 2, such as by progressive encoder 206. Where a sequence of values is quantized, each value within the sequence may be quantized, rather than the sequence as a whole. That is, if the sequence comprises 10 8-bit values, each of those 8-bit values is separately quantized, rather than merely quantizing the full 80 bit sequence of those 10 values as a whole.

After the data has been quantized, the quantized transformed data may be stored, for instance in a frame buffer or other such memory. One or more additional processing steps may also be performed, including, but not limited to performing a differencing operation and/or a linearization operation.

Progressive encoding may then be performed on the quantized and/or linearized DWT coefficients. Once at least a portion of the processing steps described above have been performed, the data may be progressively encoded. The progressive encoder 206 may be configured to produce multiple tile parts. For instance, to accomplish progressive encoding, a progressive encoder 206 may divide a tile packet broken down into bands, and further broken down into code blocks into a plurality of parts. The progressive encoder 206 may be configured to divide the code blocks of each band into sections, where a first section of code blocks (hereinafter also referred to as a first part) may be used to decode an image at a lower quality, and successive code blocks (hereinafter also referred to as subsequent or second, third parts, etc.) can be incorporated into the decoder to increase the quality of the image.

From operation 304, the routine 300 continues to operation 306, where an initial data part is encoded. To perform an initial progressive pass, an initial progressive pass operation may be performed on a first data image part. For instance, the progressive encoder 206 may process a section of the lowest sub-band (e.g., LL3) of a divided transformed tile. A data image part may include collection of transform coefficients as described above. The first progressive pass for a tile may occur when the progressive encoder 206 receives new image components (in the form of a pixel tile or frame) to encode and send to a decoder. Prior to encoding a first part, a second quantization step may be performed on the first part coefficients. For instance, the progressive encoder 206 may quantize the coefficients further. The quantization step may be performed on the data received from another component (e.g., image processing component 204). In some embodiments, a first data part to be encoded may be obtained by quantizing tile coefficients to remove one or more bits. In the first part of a progressive encode, in a given band, the number of bits removed may be the same for each coefficient. If the first pass is processing a lowest sub-band section, the lowest sub-band may be quantized toward negative infinity and the quantized result may be subtracted from a next lowest sub-band part before encoding the next lowest sub-band part.

During a first pass, a first part may be encoded using any encoding scheme. In preferred embodiments, the encoding scheme is an entropy-encoding scheme (e.g., any encoding scheme providing lossless data compression). In some embodiments, a first pass may be entropy encoded by the progressive encoder 206 using run-length algorithm configured to losslessly encode the first data part (e.g., by compressing runs of zeros). According to some embodiments, the run-length coding algorithm may be a Run-Length Golomb Rice (RLGR) algorithm. The RLGR algorithm may be configured to adaptively switch between run-length encoding of zeros and Golomb-Rice coding of nonzero coefficients. Run-length encoding may be performed on the data to compress the data losslessly by compressing runs of zeros. In the embodiments described herein, run-length encoding is performed by progressive encoder 206 of FIG. 2. Run-length compression may comprise combining any consecutive values of 0 into one value that represents that run, as well as placing a reserved divider number in between any values. A run-length compression component takes in the input data and produces run-length compressed data. This run-length encoded data may comprise an array of values. However, the number of values stored in a run-length compressed array may be different from the number of values stored in the original data array. As compared to an original array, the run-length compressed array may include fewer values where the runs of zeroes are combined. In an example of run-length compression, there may be N values in data taken as input. These N values may be stored in an array of 16-bit short integers in 2*magnitude+sign format. Run-length compression may use these N values as input values and assign each to a separate one of N threads that will execute on a CPU (or in some instances, on a graphics process unit (GPU)). The CPU may then compress runs of zeroes with a number that indicates how many zeroes are in the run. The operation of run-length compression may be expressed in pseudo-code in a C-style syntax as follows. It may be appreciated that, while pseudo-code that executes on a CPU (and/or GPU) is described herein, run-length compression may be implemented entirely in hardware, or a combination of hardware and code that executes on a CPU and/or GPU. Golomb-Rice coding may be preferred for situations in which the occurrence of small values in the input stream is significantly more likely than large values, such as during an initial progressive pass, where the image data is highly compressed to remove the smaller frequency values and produce a lower quality image. In embodiments, Golomb-Rice may be performed by progressive encoder 206 of FIG. 2.

When first and subsequent progressive passes are performed, data to be encoded may be at various stages, including Data Already Sent, Data To Send, and Data Remaining To Be Sent. Data Already Sent may represent the cumulated data that has been transmitted through the previous passes. Data To Send may represent the data to be transmitted in the current pass, and Data Remaining to be Sent may represent the data that remains to be sent after a current pass. For an initial pass, the Data Already Sent may have a value of zero. The Data to Send value for an initial pass may be a percentage of the target quality desired by the client. A first part target size may be requested by a client. For instance, a client may request an image compressed to a percentage of the target quality. For instance, a first request may be for compression to 25% of a desired target quality. The progressive encoder 206 may receive the request and process the request accordingly. Specifically, a Data To Send value may be calculated based on the request, and a first data part (e.g., code block section 502) corresponding with the request may be A Data Remaining to Send value may also be determined, for use in future calculations.

From operation 306, the routine 300 continues to operation 308, where first pass data is transmitted to the client. For a first pass, the progressive encoder 206 may be configured to output the encoded data to the client across a communications network. An inverse DWT may be utilized to recompose the image at the client. Specifically, where a DWT has been used to decompose an image to third-level sub-bands, an inverse DWT may be used to compose the third-level sub band images into a second-level LL sub-band image. The inverse DWT may then be used to take the second-level LL sub-band image, a second-level LH sub-band image, a second-level HL sub-band image, and a second-level HH sub-band image and compose them to form first-level a LL sub-band image. Finally, the inverse DWT may be used to take the first-level LL sub-band image part (and subsequent parts in subsequent decodes), a first-level LH sub-band image part, a first-level HL sub-band image part, and a first-level HH sub-band image part and compose them into the image.

From operation 308, the routine 300 continues to operation 310, where a least a portion of the data removed to form the first part is reintroduced. The step of data reintroduction may be performed if the progressive encoder 206 receives an indication that a tile being upgraded has remained static for a predetermined amount of time (e.g., 4-5 seconds). If so, a next tile part (e.g., code block section 504) may be reintroduced based in part by the determination that a target quality has not been achieved. The next part may include one or more of the bits removed from the first part. The number of bits reintroduced may be determined by a client request for additional data. For instance, the progressive encoder 206 may then be configured to reintroduce at least a portion of the tile coefficients that were dropped in the initial pass. A second part may correspond to an amount of data needed to take an image quality level from 25% to 50%. The amount of bits to encode in a second part may be determined by an amount of data ready to send in a successive part. For instance, the data ready to send may be the difference between the total amount of data requested for a previous and current part and the data already sent. As with the first progressive pass, all bands of the transform may be processed simultaneously. Specifically, compression to the specified image quality may be applied to each subsequent code block section (e.g., second part, third part, etc.) associated with each band (e.g., the 10 bands in the example above of FIG. 4) of the transform. Thus, for a successive part in a given band, the number of restituted bits may be the same for each coefficient.

From operation 310, the routine 300 continues to operation 312, where the second part is encoded. For instance, the progressive encoder 206 may then encode a second part of the data to continue to upgrade the quality of an image tile. The progressive encoder 206 may utilize the previously calculated Data Remaining To Send, quantize the data, and then either encode the data using Simplified Run-Length (SRL) encoding or send the data as raw bits. SRL encoding is an entropy encoding scheme that is based on the fact that the maximum magnitude of any element to be sent is known. SLR encoding may utilize a zero run-length engine (similar to an RLGR entropy encoder) to encode zero elements. However, encoding nonzero elements may be accomplished via unary-encoding (thus, Golomb-Rice coding may not be utilized during subsequent progressive passes).

In subsequent progressive passes, for a given element characterized as Data To Send, a decision may be made by the progressive encoder 206 whether to SRL-encoded data or raw bits. Because a second part may include additional high frequency values, the progressive encoder 206 may utilize simplified run-length encoding or simply send the data as raw bits. The progressive encoder 206 may determine which to send by determining what the client has already decoded. When restituting bits for a given coefficient, if, before restituting these bits the value is zero (e.g., code block section 506), the value produced by combining the restituted bits and the sign is encoded using SRL encoding. SRL encoding may be configured to operate on values with a small number of bits (e.g., code block sections 504, 506, 508). When SRL encoding is performed on 1 bit, the only possible non-zero values are “−1” and “+1”, and only the sign is written as one bit. Also, if a data element characterized as Data Already Sent is zero, then the coefficients in a next pass may be SRL encoded.

Alternatively, the progressive encoder 206 may transmit the raw bits of each code block (e.g. code block sections 510, 512), where raw bits may be sent as a simple bit stream. For instance, if the corresponding element in Data Already Sent is nonzero, the absolute value of the corresponding element may be transmitted as a raw bit. For raw bits the sign may have already been sent by the previous SRL or RlGr part. For a lowest low pass band element in an original tile, the upgrade element is generally positive, and may therefore be sent as a raw bit. In other embodiments, a subsequent part may be entropy-encoded similar to the first part described above.

From operation 312, the routine 300 continues to operation 314, where subsequent pass data is transmitted to the client. After each progressive pass, the data that has been sent is added to the previously sent data. For instance, progressively encoded sections may be transmitted to a client computer across a communications network. After the computer upon which the present operations are executed has encoded data band, it may transmit the encoded data band to the client computer. The client computer may receive the encoded data band, and then decode the data to recreate the data band data. The computer may send one or more consecutive encoded data bands to the client computer until all data has been encoded and transmitted, or until target image quality is achieved. The client computer decodes a first part, receives and downloads a second part, combines the second part with the first part and so on until all bits have been processed or an image of a target quality is produced. Since the additional encoded bands comprise additional image data, as the client device decoder combines received encoded data bands the image quality may improve over time. At all stages, the image may be displayed via a display device.

Operations 310-314 may repeat as many times as necessary to achieve a target quality, or until all bits have been encoded. For instance, subsequent parts may be reintroduced and progressively encoded until all bits have been restituted (e.g., until Data Remaining To Send is zero) or until a target quality is achieved. From operation 314, the routine 300 may terminate at operation 316.

In some embodiments, the progressive encoder 206 may be configured to encode the coefficients corresponding to an entire frame, or coefficients corresponding to a difference between a current tile and a previous tile. In either scenario, progressive encoding may be applied. However, a number of encoding passes may vary depending on how many coefficients are progressively encoded.

Embodiments described in the above system and method may be implemented as a computer process, a computing system or as an article of manufacture such as a computer program product or computer readable media. The computer program product may be a computer storage media or device readable by a computer system and encoding a computer program of instructions for executing a computer process.

The example systems and methods in FIGS. 1-5 have been described with specific client devices, applications, modules, and interactions that may execute in conjunction with an application program that runs on an operating system on a personal computer. Embodiments are not limited to systems according to these example configurations. Furthermore, specific protocols and/or interfaces may be implemented in a similar manner using the principles described herein.

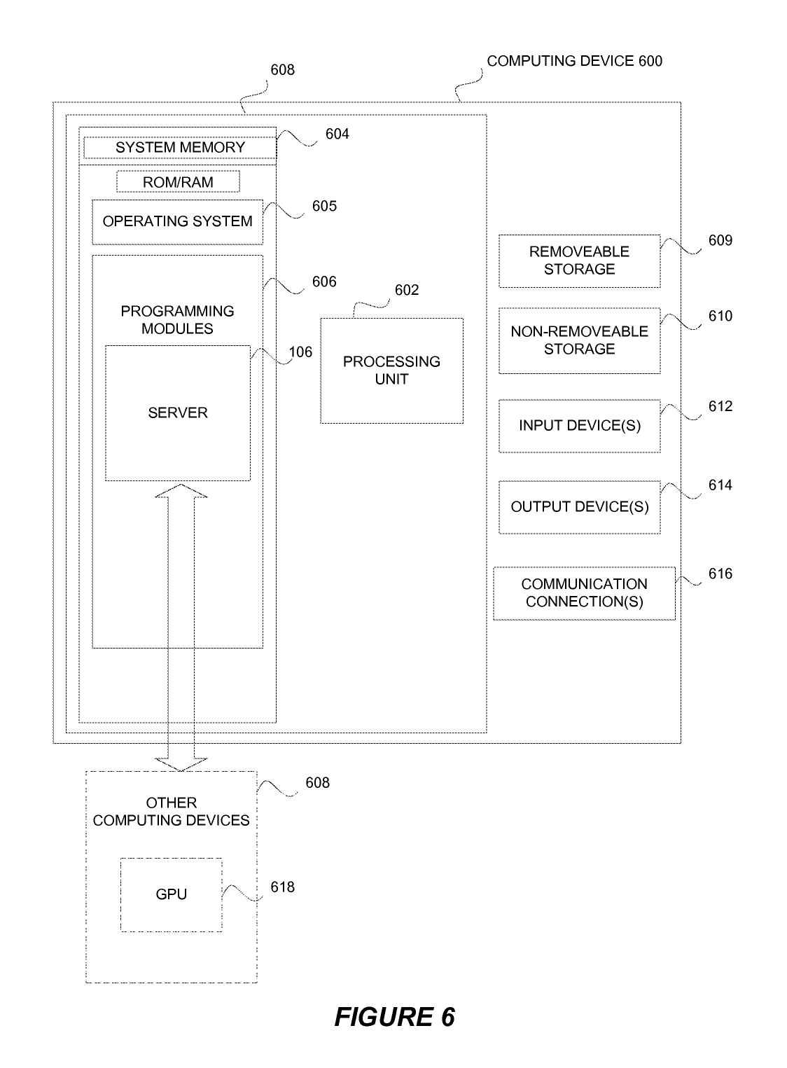

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIG. 6 and its associated description provide a discussion of a variety of operating environments in which embodiments may be practiced. However, the devices and systems illustrated and discussed with respect to FIGS. 6-8 are for purposes of example and illustration and are not limiting of a vast number of computing device configurations that may be utilized for practicing embodiments, described herein.

FIG. 6 is a block diagram illustrating example physical components of a computing device 600 with which embodiments may be practiced. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination. System memory 604 may include operating system 605 and one or more programming modules 606. Operating system 605, for example, may be suitable for controlling the operation of computing device 600. Furthermore, embodiments may be practiced in conjunction with a graphics library, other operating systems, or any other application program and is not limited to any particular application or system. This basic configuration is illustrated in FIG. 6 by those components (e.g., graphics processing unit (GPU) 618) within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610.

As stated above, a number of program modules and data files may be stored in system memory 604, including operating system 605. While executing on processing unit 602, programming modules 606 may perform processes including, for example, one or more of the processes described above with reference to FIGS. 1-5. The aforementioned processes are an example, and processing unit 602 may perform other processes. Other programming modules that may be used in accordance with embodiments may include browsers, database applications, etc.

Generally, consistent with embodiments, program modules may include routines, programs, components, data structures, and other types of structures that may perform particular tasks or that may implement particular abstract data types. Moreover, embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Furthermore, embodiments may be practiced in an electrical circuit comprising discrete electronic elements, packaged or integrated electronic chips containing logic gates, a circuit utilizing a microprocessor, or on a single chip containing electronic elements or microprocessors. For example, embodiments may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may be operated via application-specific logic integrated with other components of the computing device/system 600 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

Embodiments, for example, may be implemented as a computer process (method), a computing system, or as an article of manufacture, such as a computer program product or tangible computer-readable storage medium. The computer program product may be a computer-readable storage medium readable by a computer system and tangibly encoding a computer program of instructions for executing a computer process. The term computer-readable storage medium as used herein may include computer storage media. Computer storage media may include volatile and nonvolatile, removable and non-removable media implemented in any method or technology for storage of information, such as computer-readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, etc. Output device(s) such as a display, speakers, a printer, etc. may also be included. The aforementioned devices are examples and others may be used.

Communication media may be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments herein may be used in connection with mobile computing devices alone or in combination with any number of computer systems, such as in desktop environments, laptop or notebook computer systems, multiprocessor systems, micro-processor based or programmable consumer electronics, network PCs, mini computers, main frame computers and the like. Embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments.

Embodiments, for example, are described above with reference to block diagrams and/or operational illustrations of methods, systems, and computer program products according to embodiments. The functions/acts noted in the blocks may occur out of the order as shown in any flowchart or described herein with reference to FIGS. 1-8. For example, two processes shown or described in succession may in fact be executed substantially concurrently or the blocks may sometimes be executed in the reverse order, depending upon the functionality/acts involved.

While certain embodiments have been described, other embodiments may exist. Furthermore, although embodiments have been described as being associated with data stored in memory and other storage mediums, data can also be stored on or read from other types of computer-readable storage media, such as secondary storage devices, like hard disks, floppy disks, a CD-ROM, or other forms of RAM or ROM. Further, the disclosed processes may be modified in any manner, including by reordering and/or inserting or deleting a step or process, without departing from the embodiments.

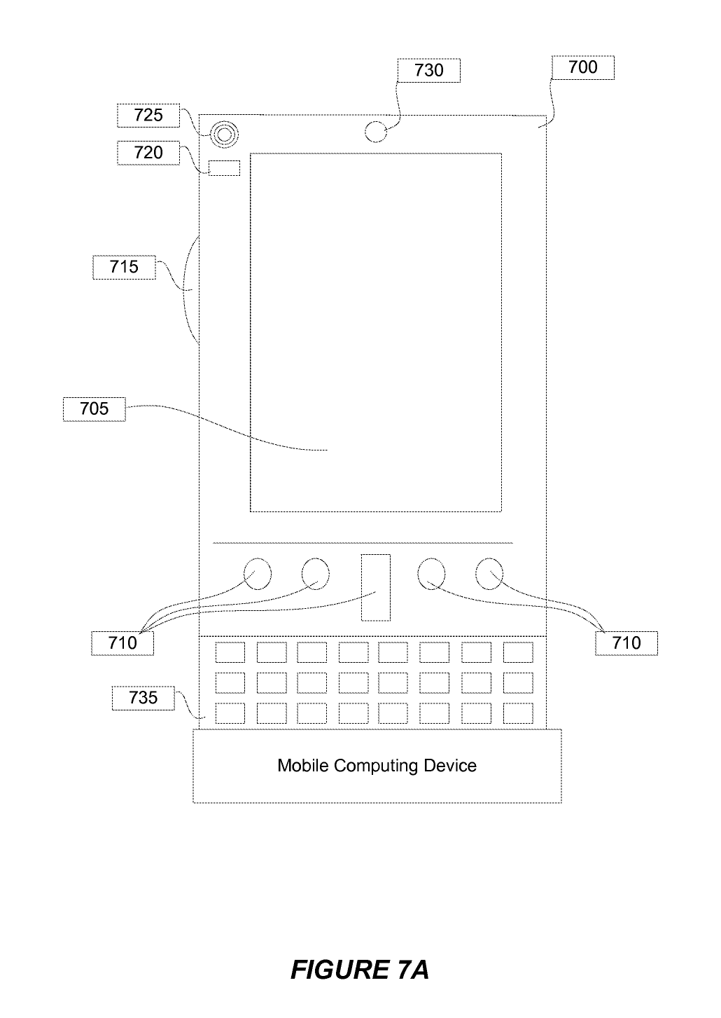

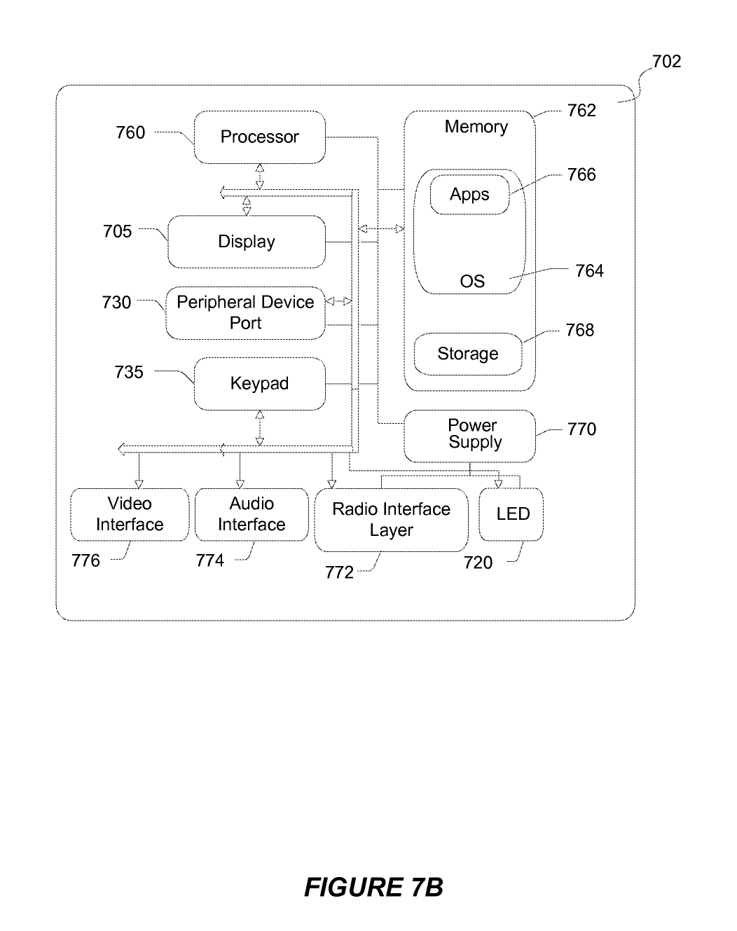

FIGS. 7A and 7B illustrate a mobile computing device 700, for example, a mobile telephone, a smart phone, a tablet personal computer, a laptop computer, and the like, with which embodiments of the present disclosure may be practiced. With reference to FIG. 7A, an exemplary mobile computing device 700 for implementing the embodiments is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative embodiments, mobile computing device 700 may incorporate more or less input elements. For example, the display 705 may not be a touch screen in some embodiments. In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display. In various embodiments, the output elements include the display 705 for showing a graphical user interface (GUI), a visual indicator 720 (e.g., a light emitting diode), and/or an audio transducer 725 (e.g., a speaker). In some embodiments, the mobile computing device 700 incorporates a vibration transducer for providing the user with tactile feedback. In yet another embodiment, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

Although described herein in combination with the mobile computing device 700, in alternative embodiments, features of the present disclosure may be used in combination with any number of computer systems, such as desktop environments, laptop or notebook computer systems, multiprocessor systems, micro-processor based or programmable consumer electronics, network PCs, mini computers, main frame computers and the like. Embodiments of the present disclosure may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present disclosure.

FIG. 7B is a block diagram illustrating the architecture of one embodiment of a mobile computing device. That is, the mobile computing device 700 can incorporate a system (i.e., an architecture) 702 to implement some embodiments. In one embodiment, the system 702 is implemented as a “smart phone” capable of running one or more applications (e.g., browser, e-mail, calendaring, contact managers, messaging clients, games, and media clients/players). In some embodiments, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700.

The system 702 has a power supply 770, which may be implemented as one or more batteries. The power supply 770 might further include an external power source, such as an AC adapter or a powered docking cradle that supplements or recharges the batteries.

The system 702 may also include a radio 772 that performs the function of transmitting and receiving radio frequency communications. The radio 772 facilitates wireless connectivity between the system 702 and the “outside world”, via a communications carrier or service provider. Transmissions to and from the radio 772 are conducted under control of the operating system 764. In other words, communications received by the radio 772 may be disseminated to the application programs 766 via the operating system 764, and vice versa.

The radio 772 allows the system 702 to communicate with other computing devices, such as over a network. The radio 772 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of the system 702 provides notifications using the visual indicator 720 that can be used to provide visual notifications and/or an audio interface 774 producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768. Computer storage media may include volatile and nonvolatile, removable and non-removable media implemented in any method or technology for storage of information, such as computer readable instructions, data structures, program modules, or other data.

Data/information generated or captured by the mobile computing device 700 and stored via the system 702 may be stored locally on the mobile computing device 700, as described above, or the data may be stored on any number of storage media that may be accessed by the device via the radio 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio 772 or via a distributed computing network. Similarly, such data/information may be readily transferred between computing devices for storage and use according to well-known data/information transfer and storage means, including electronic mail and collaborative data/information sharing systems.

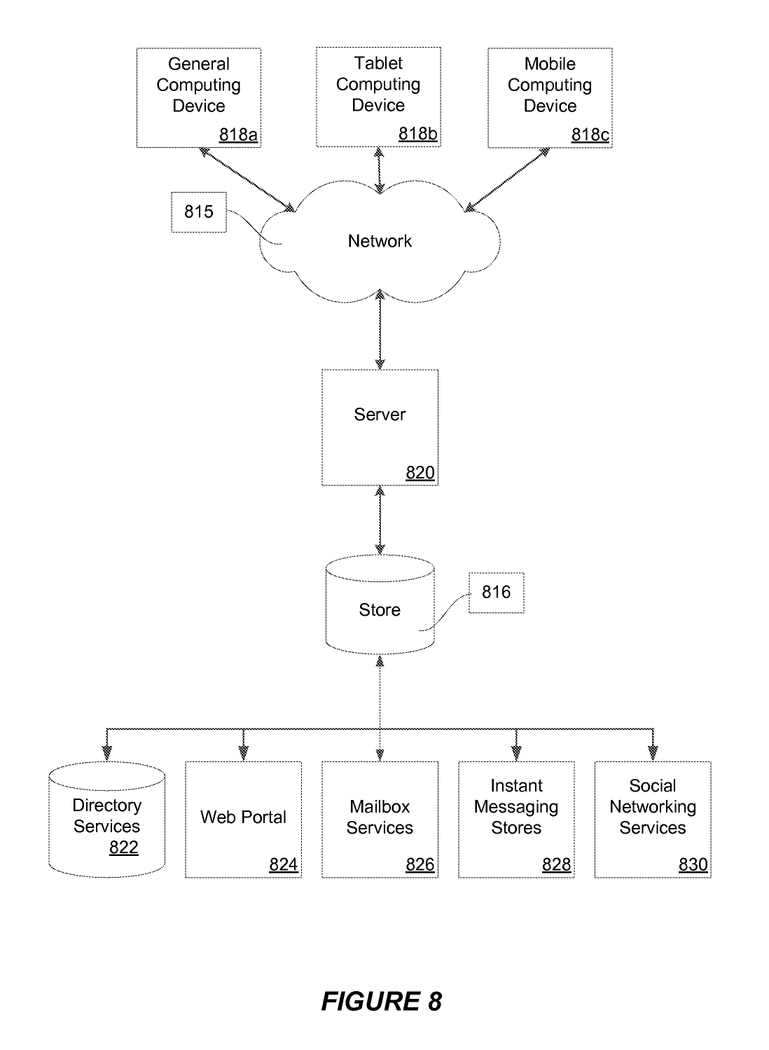

FIG. 8 illustrates one embodiment of the architecture of a system for providing converted documents to one or more client devices, as described above. In certain embodiments, the converted documents may be stored in different communication channels or other storage types. For example, various documents, including the converted documents, may be stored using a directory service 822, a web portal 824, a mailbox service 826, an instant messaging store 828, or a social networking site 830. The various components of the system 100 use any of these types of systems or the like for enabling data utilization, as described herein. A server 820 may provide the converted paragraphs to clients. The server 820 may provide the converted paragraphs and the status updates over the web to clients through a network 815. By way of example, the client computing device 818 may be implemented as the computing device 800 and embodied in a personal computer 818a, a tablet computing device 818b and/or a mobile computing device 818c (e.g., a smart phone). Any of these embodiments of the client computing device 818 may obtain content from the store 816. In various embodiments, the types of networks used for communication between the computing devices that make up the present disclosure include, but are not limited to, an internet, an intranet, wide area networks (WAN), local area networks (LAN), and virtual private networks (VPN). In the present application, the networks include the enterprise network and the network through which the client computing device accesses the enterprise network (i.e., the client network). In one embodiment, the client network is part of the enterprise network. In another embodiment, the client network is a separate network accessing the enterprise network through externally available entry points, such as a gateway, a remote access protocol, or a public or private internet address.

It will be apparent to those skilled in the art that various modifications or variations may be made to embodiments without departing from the scope or spirit. Other embodiments are apparent to those skilled in the art from consideration of the specification and practice of the embodiments disclosed herein.

What is claimed:

1. A method for progressively encoding image tile data comprising:
receiving indication that image tile data is to be updated;
dividing the image tile data into one or more parts;
encoding an initial data part in a first pass;
transmitting first pass data to a client;
reintroducing at least a portion of the data removed to create the initial data part to form a second data part;
encoding the second data part in a second pass; and
transmitting the second pass data to the client.

2. The method of claim 1, wherein the initial data part is Run-Length Golomb Rice encoded.

3. The method of claim 1, wherein the second data part is either Simplified Run-Length encoded or sent as one or more raw bits.

4. The method of claim 1, further including performing a transform operation on the image tile prior to dividing the image tile data into one or more parts.

5. The method of claim 4, further including individually quantizing the initial data part and the second data part.

6. The method of claim 1, further including determining which portion of second pass data to encode using Simplified Run-Length encoding or to transmit as raw bits.

7. The method of claim 6, wherein the step of reintroducing at least a portion of the data is performed upon receiving an indication that the image tile data has remained static for a pre-determined amount of time.

8. The method of claim 7, further including reintroducing at least a second portion of the data removed to create the initial data part to form a third data part.

9. The method of claim 8, further including transmitting third portion data to the client as raw data.

10. A computer-readable medium comprising executable instructions that, when executed by a processor, progressively encodes image tile data, the computer-readable medium including instructions executable by the processor for:
receiving indication that image tile data is to be updated;
dividing the image tile data into one or more parts;
encoding an initial data part in a first pass;
transmitting first pass data to a client;
reintroducing at least a portion of the data removed to create the initial data part to form a second data part;
encoding the second data part in a second pass; and
transmitting the second pass data to the client.

11. The computer-readable medium of claim 10, wherein the initial data part is Run-Length Golomb Rice encoded.

12. The computer-readable medium of claim 11, wherein the second data part is either Simplified Run-Length encoded or sent as one or more raw bits.

13. The computer-readable medium of claim 10, wherein the computer-readable medium further includes instructions executable by the processor for:
performing a transform operation on an image tile prior to dividing the image tile data into one or more parts.

14. The computer-readable medium of claim 10, wherein the computer-readable medium further includes instructions executable by the processor for:
individually quantizing the initial data part and the second data part.

15. The computer-readable medium of claim 10, further including determining which portion of second pass data to encode using Simplified Run-Length encoding or to transmit as raw bits.

16. The computer-readable medium of claim 10, wherein the step of reintroducing at least a portion of the data is performed upon receiving an indication that image tile data has remained static for a pre-determined amount of time.

17. The computer-readable medium of claim 10, wherein the computer-readable medium further includes instructions executable by the processor for:
reintroducing at least a second portion of the data removed to create the initial data part to form a third data part.

18. The computer-readable medium of claim 17, wherein the computer-readable medium further includes instructions executable by the processor for:
encoding the third data part using a Simplified Run-Length algorithm in a third data pass; and
transmitting the third pass data to the client.

19. The computer-readable medium of claim 17, wherein the computer-readable medium further includes instructions executable by the processor for:
transmitting the third data part to the client as raw data.

20. A computer-readable medium comprising executable instructions that, when executed by a processor, progressively encodes image tile data, the computer-readable medium including instructions executable by the processor for:
receiving indication that image tile data is to be updated;
dividing the image tile data into one or more parts;
encoding an initial data part in a first pass, the initial data part encoded using a Run-Length Golomb Rice algorithm;
transmitting first pass data to a client;
reintroducing at least a first portion of the data removed to create the initial data part to form a second data part;
encoding the second data part in a second pass, the second pass encoded using a Simplified Run-Length algorithm;
transmitting the second pass data to the client;
reintroducing at least a second portion of the data removed to create the initial data part to form a third data part; and
transmitting the third data part to the client as raw data.
